(19) United States
(12) Patent Application Publication
(10) Pub. No.: US 2004/0129114 A1
(43) Pub. Date: Jul. 8, 2004

(54) Versatile wrench

(76) Inventor: Terence Chen, Yi Lan Hsien (TW)

Correspondence Address: Alan D. Kamrath, Rider Bennett, LLP, Suite 2000, 333 South Seventh Street, Minneapolis, MN, 55402, US

(21) Appl. No.: 10/689,427

(22) Filed: Oct. 20, 2003

Related U.S. Application Data
(63) Continuation-in-part of application No. 10/335,740, filed on Jan. 2, 2003, now abandoned.

(51) Int. Cl. B25B 13/46

(52) U.S. Cl. 81/63

(57) ABSTRACT

A wrench includes a head, a handle, a socket, a pawl and a switch. The head defines a horizontal tunnel. The handle extends movably through the horizontal tunnel and includes two stops attached thereto for retaining the handle on the head. The socket is rotationally connected with the head. The socket includes an internal face including a toothed portion and a non-circular portion. The pawl is put between the head and the socket. The pawl includes a first member with a toothed side and a second member with a toothed front side. The toothed side of selective one of the members of the pawl engages with the toothed portion of the internal face of the socket so that the head can drive the socket through the pawl in selective one of two directions. The switch is connected with the pawl so that the switch can be switched so as to engage the toothed side of selective one of the members of the pawl with the toothed portion of the internal face of the socket.

### CROSS-REFERENCE

The present application is a continuation-in-part application of U.S. patent application Ser. No. 10/335,740 of which the disclosure is incorporated herein for reference.

### BACKGROUND OF INVENTION

1. Field of Invention

The present invention relates to a versatile wrench.

2. Related Prior Art

Taiwanese Patent Publication No. 366849 discloses a wrench including a box end 12 and an annular gear 121 put in the box end 12. A direction control device (not shown) is arranged between the box end 12 and the annular gear 121. The direction control device can be switched between a position where the box end 12 can drive the annular gear 121 in a direction and another position where the box end 12 can drive the annular gear 121 in an opposite direction. The annular gear 121 includes a toothed internal face for engagement with a polygonal periphery of a socket 2 including a plurality of aspects 21. A C-ring 3 is put in an annular groove 1211 defined in the toothed internal face of the annular gear 121. A plurality of bosses 31 is formed on an internal face of the C-ring 13. As a socket 2 is inserted in the C-ring 13, some of the aspects 21 are engaged with the bosses 31. However, the bosses 31 only provide inadequate strength. Furthermore, the toothed internal face of the annular gear 121 becomes redundant.

Taiwanese Patent Publication No. 423355 discloses a wrench 3 with a box end for engagement with a direction control device. The direction control device includes a body 1 including a square joint 11 for insertion in a square hole defined in a socket 2. The body 1 defines a hole 13. An axle 14 is inserted in the hole 13. A switch 15 is attached to the axle 14. A pawl 17 includes two ends 172 and an intermediate portion 171 pivotally mounted on the body 1. The axle 14 is rotated between two positions. In each of the positions of the axle 14, the switch 15 pushes one of the ends 172 of the pawl 17 beyond the body 1 for engagement with one of dents 32 defined in an internal face of the box end of the wrench 3. However, the ends 172 only provide inadequate strength.

Therefore, the present invention is intended to obviate or at least alleviate the problems encountered in prior art.

### SUMMARY OF INVENTION

It is the primary objective of the present invention to provide a robust wrench that can be switched between a position for driving a bolt or nut in a direction and another position for driving the bolt or nut in an opposite direction.

According to the present invention, a wrench includes a head, a handle, a socket, a pawl and a switch. The head defines a horizontal tunnel. The handle extends movably through the horizontal tunnel and includes two stops attached thereto for retaining the handle on the head. The socket is rotationally connected with the head. The socket includes an internal face including a toothed portion and a non-circular portion. The pawl is put between the head and the socket. The pawl includes a first member with a toothed side and a second member with a toothed front side. The toothed side of selective one of the members of the pawl engages with the toothed portion of the internal face of the socket so that the head can drive the socket through the pawl in selective one of two directions. The switch is connected with the pawl so that the switch can be switched so as to engage the toothed side of selective one of the members of the pawl with the toothed portion of the internal face of the socket.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is a perspective view of a wrench according to a first embodiment of the present invention.

FIG. 2 is an exploded view of the wrench of FIG. 1.

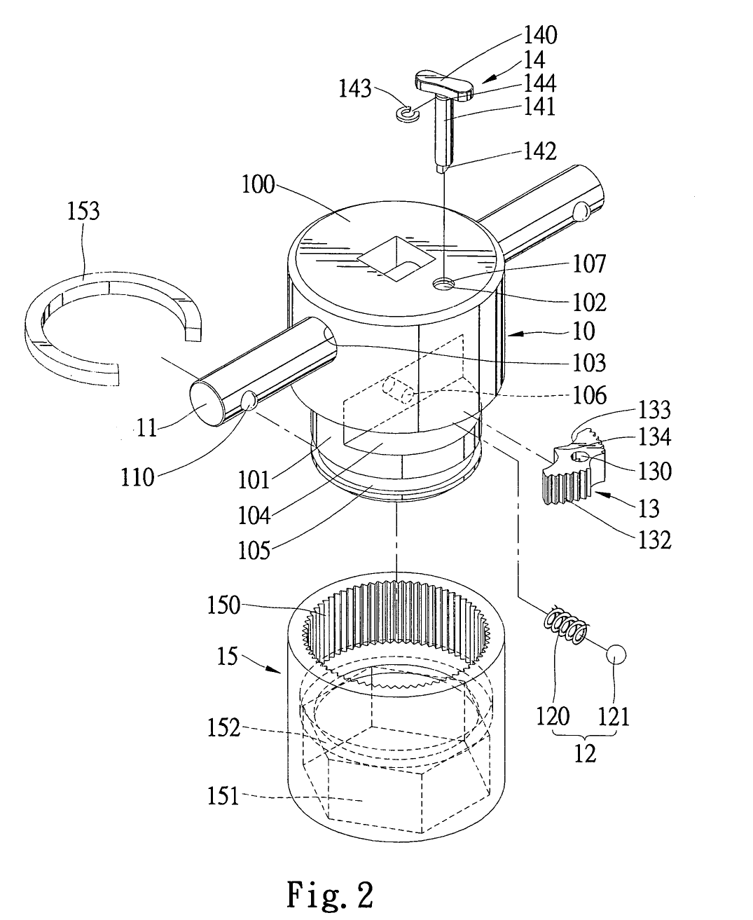

FIG. 3 is a cross-sectional view taken along a line 3-3 in FIG. 1.

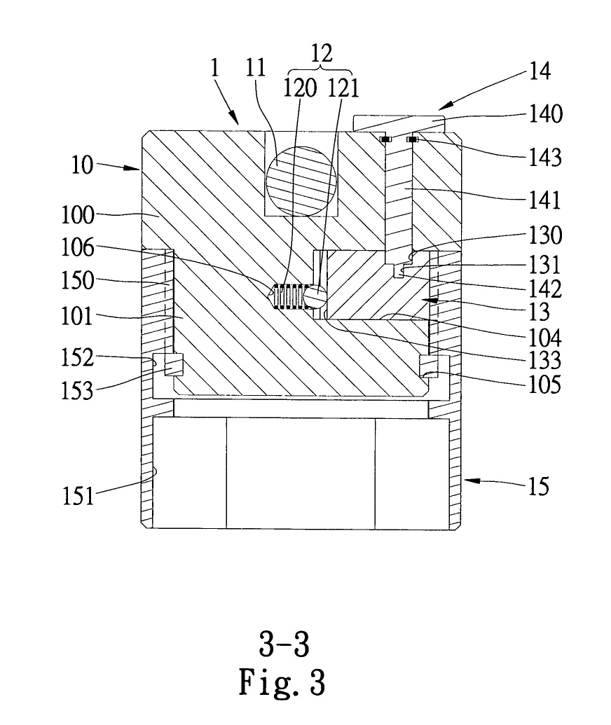

FIG. 4 is a cross-sectional view taken along a line 4-4 in FIG. 1.

FIG. 5 is a side view of the wrench of FIG. 1 engaged with a bolt.

FIG. 6 is a cut-away side view of the wrench of FIG. 1 engaged with a joint.

FIG. 7 is a perspective view of a wrench according to a second embodiment of the present invention.

FIG. 8 is an exploded view of the wrench of FIG. 7.

FIG. 9 is a cross-sectional view of the wrench of FIG. 7.

FIG. 10 is another cross-sectional view of the wrench of FIG. 7.

FIG. 11 is a perspective view of a wrench according to a third embodiment of the present invention.

FIG. 12 is an exploded view of the wrench of FIG. 11.

FIG. 13 is a cross-sectional view of the wrench of FIG. 11.

FIG. 14 is another cross-sectional view of the wrench of FIG. 11.

### DETAILED DESCRIPTION OF EMBODIMENTS

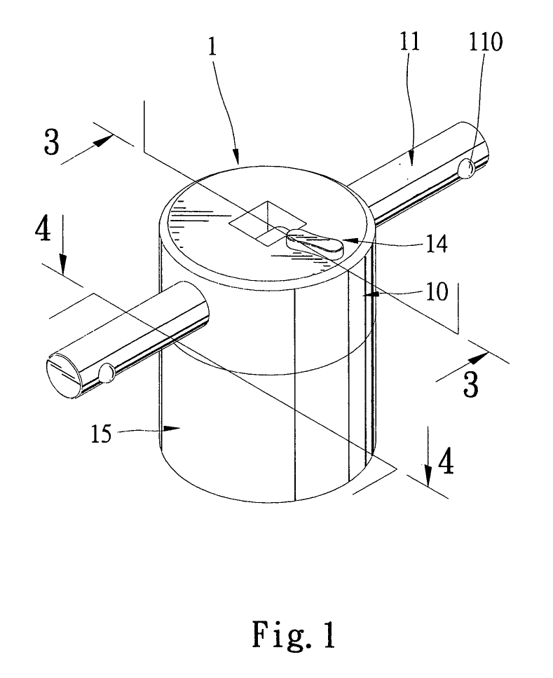

Referring to FIGS. 1˜3, according to a first embodiment of the present invention, a wrench 1 includes a head 10, a handle 11, a positioning device 12, a pawl 13, a switch 14 and a socket 15.

The head 10 includes an upper portion 100 and a lower portion 101 extending from the upper portion 100. The upper portion 100 defines a vertical tunnel 102 and a horizontal tunnel 103. An annular groove 107 is defined in the wall of the vertical tunnel 102. The lower portion 101 defines an open space 104 communicated with vertical tunnel 102, a hole 106 communicated with the space 104 and an annular groove 105 below the space 104.

The handle 11 is movably inserted through the tunnel 103. Two stops 110 are installed at each end of the handle 11 so as to retain the handle 11 on the head 10.

The positioning device 12 includes a spring 120 and a ball 121. The spring 120 is put in the hole 231 before the ball 121.

The pawl 13 includes a first portion and a second portion. A point 134 extends from a rear side of the pawl 13 between the first and second portions. Each portion of the pawl 13 includes a toothed front side 132 and a concave rear side 133. The pawl 13 defines a hole 130 and a slot 131 communicated with the hole 130. The pawl 13 is put in the open space 104 so that the ball 121 can selectively be put in the concave rear side of the first or second portion of the pawl 13.

The switch 14 includes a knob 140, a shaft 141 extending from the knob 140 and a tongue 142 extending from the shaft 141. The shaft 141 defines an annular groove 144 below the knob 140. The shaft 141 is inserted into the hole 130 through the vertical tunnel 102 so that the tongue 142 is fit in the slot 131. Thus, the pawl 13 is rotational together with the switch 14.

A C-ring 143 includes an external edge put in the annular groove 107 and an internal edge put in the annular groove 144 so as to retain the shaft 141 in the vertical tunnel 102.

The socket 15 includes an internal face including a toothed portion 150 for engagement with the toothed front side 132 of the first or second portion of the pawl 13, a non-circular and preferably polygonal portion 151 for engagement with a bolt or nut and an annular groove 152 defined therein between the toothed portion 150 and the non-circular portion 151.

A C-ring 153 includes an internal edge put in the annular groove 105 and an external edge put in the annular groove 152 so as to rotationally connect the head 10 with the socket 15.

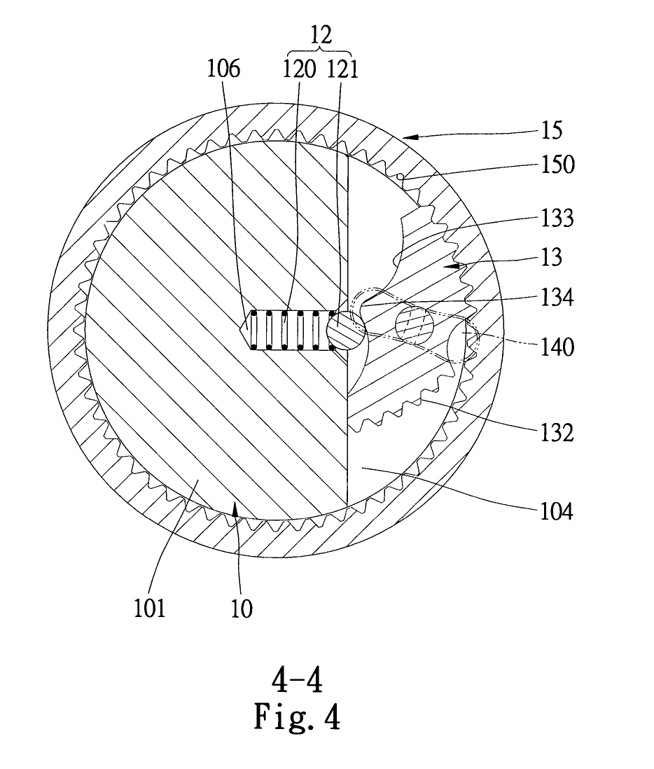

Referring to FIG. 4, the wrench 1 is in a counterclockwise mode. The toothed front side 132 of the first portion of the pawl 13 engages with the toothed portion 150 of the internal face of the socket 15. The ball 121 contacts the concave rear side 133 of the second portion of the pawl 13. The second portion of the pawl 13 contacts the lower portion 101. As the head 10 is rotated counterclockwise, the pawl 13 is stuck between the lower portion 101 and the socket 15 so that the socket 15 is rotated counterclockwise. As the head 10 is rotated clockwise, the ball 121 is moved along the concave rear side 133, thus moving the second portion of the pawl 13 from the lower portion 101, and the toothed front side 132 from the toothed portion 150. Thus, the socket 15 remains still.

By means of operating the switch 14, the pawl 13 can be pivoted so as to move the wrench 1 to a clockwise mode. The toothed front side 132 of the second portion of the pawl 13 engages with the toothed portion 150 of the internal face of the socket 15. The ball 121 contacts the concave rear side 133 of the first portion of the pawl 13. The first portion of the pawl 13 contacts the lower portion 101. As the head 10 is rotated clockwise, the pawl 13 is stuck between the lower portion 101 and the socket 15 so that the socket 15 is rotated clockwise. As the head 10 is rotated counterclockwise, the ball 121 is moved along the concave rear side 133, thus moving the first portion of the pawl 13 from the lower portion 101, and the toothed front side 132 from the toothed portion 150. Thus, the socket 15 remains still.

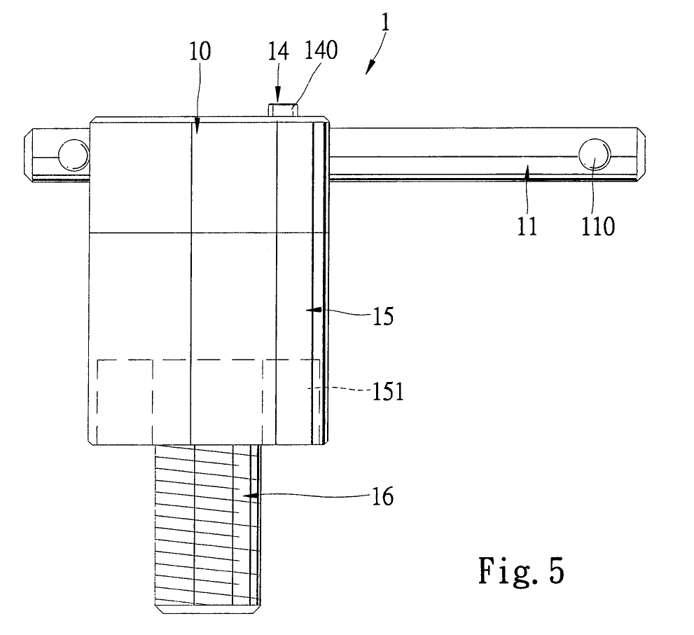

FIG. 5 shows the socket 15 engaged with a bolt.

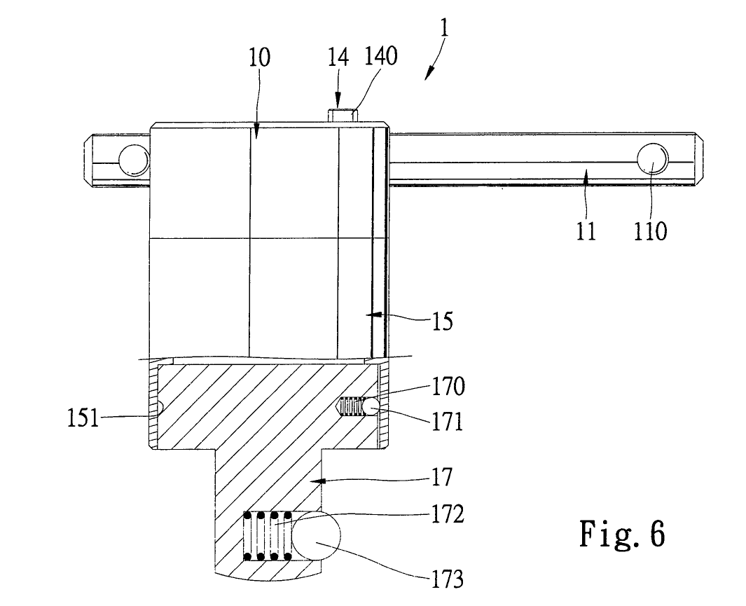

FIG. 6 shows the socket 15 engaged with a joint 17. The joint 17 includes an upper portion for engagement with the non-circular portion of the internal face of the socket 15 and a lower portion for engagement with a non-circular internal face of another socket (not shown). A spring 170 and a ball 171 are installed at the upper portion of the joint 17. The spring 170 and the ball 171 make a spring-biased detent for holding the joint 17 to the socket 15. A spring 172 and a ball 173 are installed at the lower portion of the joint 17. The spring 172 and the ball 173 make a spring-biased detent for holding the joint 17 to the other socket.

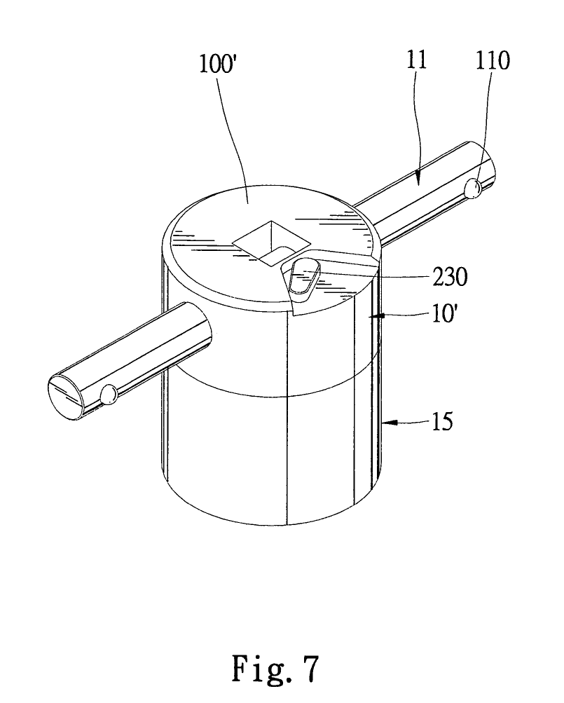

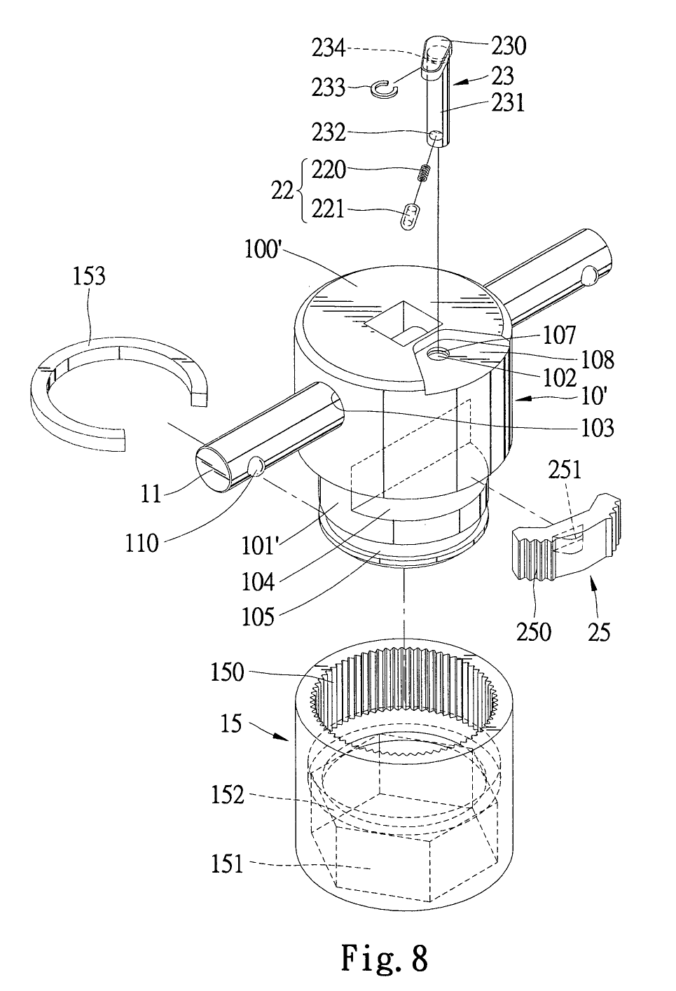

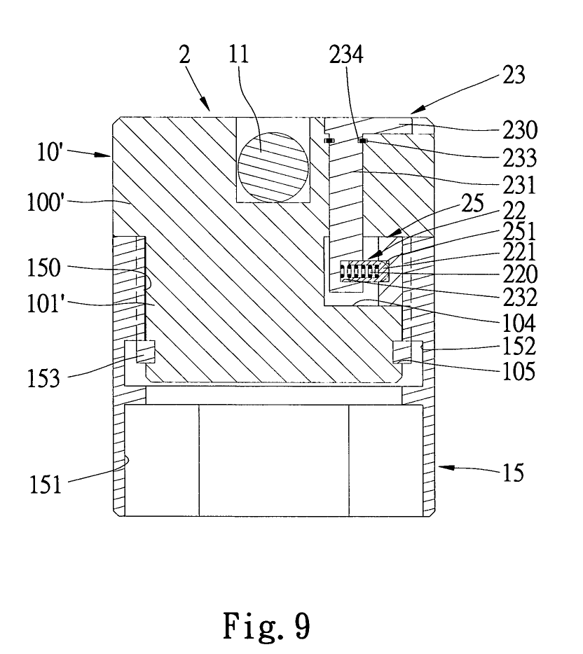

FIGS. 7 to 10 show a wrench 2 according to a second embodiment of the present invention. The second embodiment is identical to the first embodiment except for a head 10′, a switch 23 and a pawl 25 instead of the head 10, the switch 14 and the pawl 13, respectively.

The head 10′ includes an upper portion 100′ and a lower portion 101′ instead of the upper portion 100 and the lower portion 101, respectively. The upper portion 100′ is identical to the upper portion 100 except for defining a recess 108 in the top. The recess 108 is communicated with the vertical tunnel 102. The lower portion 101′ is identical to the lower portion 100 except for excluding the hole 106.

The switch 23 includes a lever 230, a shaft 231 extending from the lever 230 and a hole 232 defined in the shaft 231. The shaft 231 defines an annular groove 234 below the lever 230. The shaft 231 is inserted into the open space 104 through the vertical tunnel 102 so that the hole 232 is located in the open space 104. The lever 230 is put pivotally in the recess 108. The lever 23 extends beyond the upper portion 100′ so that it can easily be pivoted.

A C-ring 233 includes an external edge put in the annular groove 107 and an internal edge put in the annular groove 234 so as to retain the shaft 231 in the vertical tunnel 102.

A spring-biased detent 22 is installed at the shaft 231. The spring-biased detent 22 includes a spring 220 put in the hole 232 and a detent 221 put partially in the hole 232. The detent 221 is preferably shaped like a cap with a closed end and an open end. An end of the spring 220 is put into the detent 221 through the open end.

The pawl 25 includes a first portion and a second portion. A hole 251 is defined in a rear side of the pawl 13 between the first and second portions. Each portion of the pawl 25 includes a toothed front side 250. The pawl 25 is put in the open space 104 so that the detent 221 is put in the hole 251. Thus, the pawl 25 is rotational together with the switch 23.

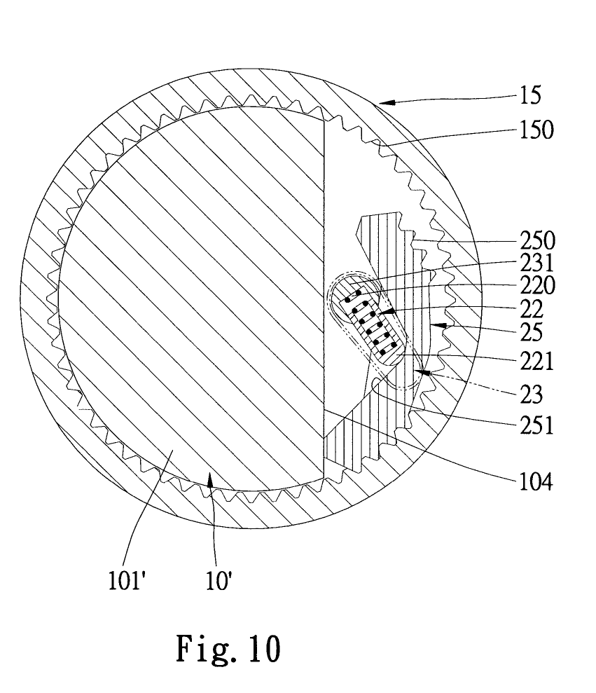

By means of operating the switch 23, the pawl 25 can be pivoted between a counterclockwise mode shown in FIG. 10 and a clockwise mode.

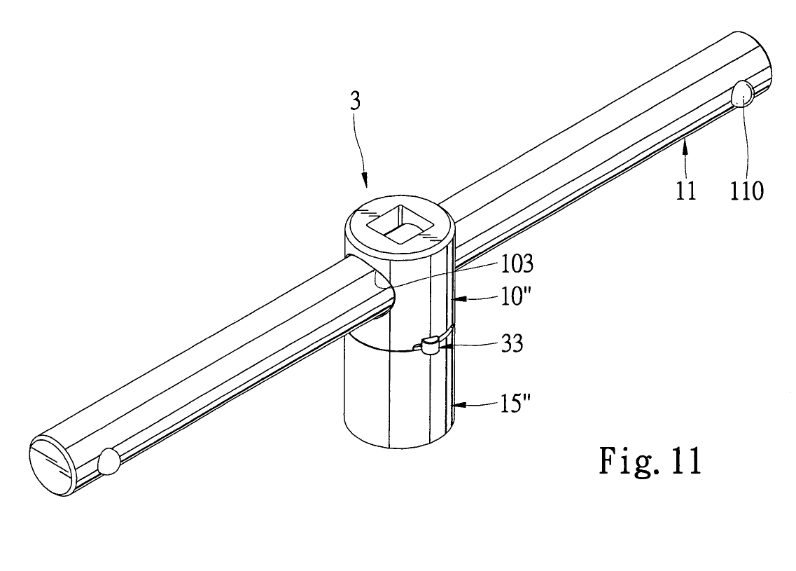

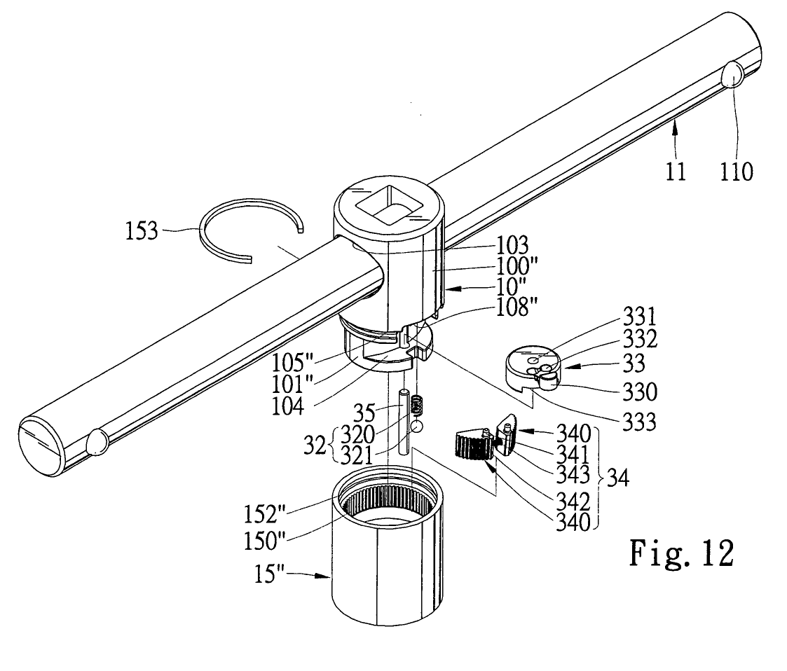

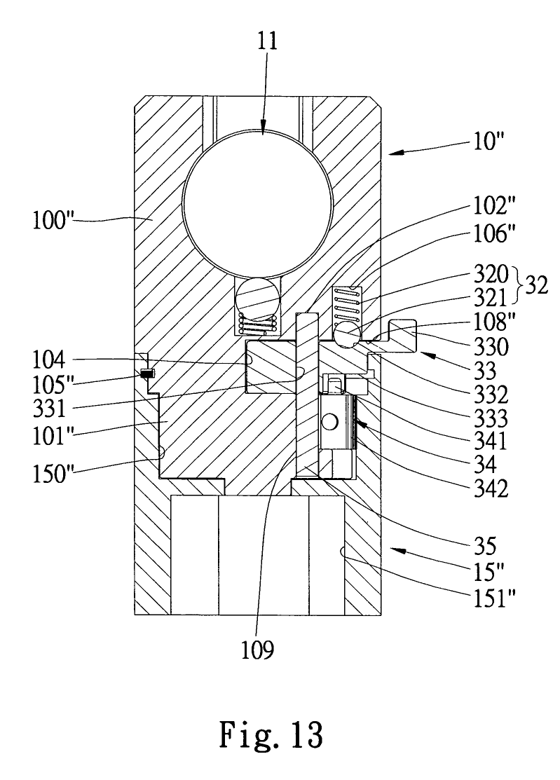

FIGS. 11 to 14 show a wrench 3 according to a third embodiment of the present invention. The third embodiment is identical to the first embodiment except for a head 10″, a socket 15″, a switch 33 and a pawl 34 instead of the head 10, the socket 15, the switch 14 and the pawl 13, respectively.

The head 10″ includes an upper portion 100″ and a lower portion 101″ instead of the upper portion 100 and the lower portion 101, respectively. The upper portion 100″ is identical to the upper portion 100 except for three features. Firstly, the upper portion 100″ defines a hole 102″ instead of the vertical tunnel 102. The hole 102″ is communicated with the open space 104. Secondly, the upper portion 100″ defines a hole 106″ communicated with the open space 104. Finally, the upper portion 100″ defines a recess 108″ communicated with the open space 104.

The lower portion 101″ is identical to the lower portion 100 except for three features. Firstly, the lower portion 101″ defines a C-groove 105″ instead of the annular groove 105. The C-groove 105″ is located above the open space 104. Secondly, the lower portion 101″ excludes the hole 106. Finally, the lower portion 101″ defines a vertical tunnel 109 communicated with the open space 104.

A spring-biased detent 32 is installed at the upper portion 100″. The spring-biased detent 32 includes a spring 320 put in the hole 106″ and a ball 321 put partially in the hole 106″.

The switch 33 includes a lever 330, an aperture 331 defined therein, two holes 332 defined in the top and a recess 333 defined in the bottom. The switch 33 is put in the open space 104. The lever 330 is put pivotally in the recess 108″. The lever 330 extends beyond the upper portion 100″ so that it can easily be pivoted. The ball 321 is put in selective one of the holes 332. A pin 35 is inserted into the vertical tunnel 109, the aperture 331 and the hole 102″.

The pawl 34 includes a first jaw 340, a second jaw 340 and a spring 343 connected between the jaws 340. Each jaw 340 includes a boss 341 formed on the top and a toothed front side 342. The pawl 34 is put in the open space 104 so that the bosses 341 are put in the recess 333.

The socket 15″ includes an internal face with an annular groove 152″ defined therein, a toothed portion 150″ formed thereon below the annular groove 152″ and a non-circular and preferably polygonal portion 151″ formed thereon below the toothed portion 150″. The toothed portion 150″ can engage with the toothed front side 342 of the first or second jaw 340. The non-circular portion 151″ can engage with a bolt or nut.

A C-ring 153 includes an internal edge put in the C-groove 105″ and an external edge put in the annular groove 152″ so as to rotationally connect the head 10″ with the socket 15″.

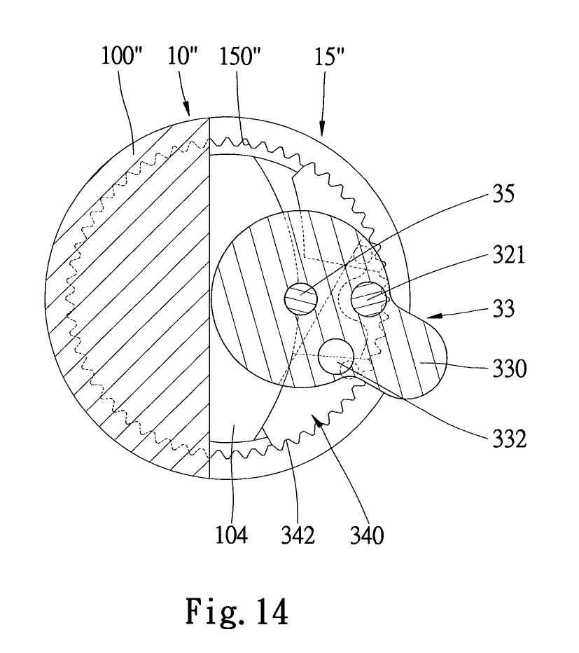

By means of operating the switch 33, the pawl 34 can be pivoted between a counterclockwise mode shown in FIG. 14 and a clockwise mode.

The present invention has been described through detailed illustration of three embodiments. Those skilled in the art can derive variations from the embodiments without departing from the scope of the present invention. Therefore, the embodiments shall not limit the scope of the present invention defined in the claims.

What is claimed is:

1. A wrench including:
a head defining a horizontal tunnel;
a handle extending movably through the horizontal tunnel and including two stops attached thereto for retaining the handle on the head;
a socket rotationally connected with the head, the socket including an internal face including a toothed portion and a non-circular portion;
a pawl put between the head and the socket, wherein the pawl includes a first member with a toothed side and a second member with a toothed front side, and the toothed side of selective one of the members of the pawl engages with the toothed portion of the internal face of the socket so that the head can drive the socket through the pawl in selective one of two directions; and
a switch connected with the pawl so that the switch can be switched so as to engage the toothed side of selective one of the members of the pawl with the toothed portion of the internal face of the socket.

2. The wrench according to claim 1 including a spring-biased detent attached to the head, wherein each of the members of the pawl includes a concave side opposite to the toothed side in order to receive the spring-biased detent.

3. The wrench according to claim 2, wherein the pawl defines a slot, and the head defines a vertical tunnel, and the switch includes a shaft extending in the vertical tunnel and a tongue extending in the slot.

4. The wrench according to claim 2, wherein the head includes a semi-cylindrical portion formed on the cylindrical portion wherein the positioning device is attached to the semi-cylindrical portion.

5. The wrench according to claim 1, wherein the switch includes a spring-biased detent attached thereto, wherein the pawl defines a recess in a side opposite to the toothed side in order to receive the spring-biased detent.

6. The wrench according to claim 5, wherein the switch includes a shaft, and the spring-biased detent is attached to the shaft, and the head defines a vertical tunnel for receiving the shaft.

7. The wrench according to claim 1 wherein the pawl includes a spring connected between the two members thereof.

8. The wrench according to claim 7 wherein each of the members of the pawl includes a boss formed on the top, and the switch defines a recess in the bottom for receiving the bosses of the members of the pawl.

9. The wrench according to claim 8 including a spring-biased detent, wherein the switch defines two holes in the top for receiving the spring-biased detent.

10. The wrench according to claim 8 including a pin, wherein the pawl defines a hole in which the pin is inserted, and the head defines a hole in which the pin is fit.
